(19) United States
(12) Patent Application Publication
(10) Pub. No.: US 2026/0001109 A1
(43) Pub. Date: Jan. 1, 2026

(54) METHOD AND APPARATUS FOR CLEANING ICE-MAKING DEVICE, AND ICE-MAKING DEVICE

(71) Applicant: WUHU MIDEA KITCHEN AND BATH APPLIANCES MFG. CO., LTD., Wuhu (CN)

(72) Inventors: Zhanli XI, Wuhu (CN); Yalin TANG, Wuhu (CN); Zhonghua LI, Wuhu (CN); Xiaowen LIU, Wuhu (CN); Yu LIN, Wuhu (CN); Yafei ZHANG, Wuhu (CN)

(21) Appl. No.: 19/206,697

(22) Filed: May 13, 2025

(30) Foreign Application Priority Data
Jun. 28, 2024 (CN) 202410873287.2

(51) Int. Cl. B08B 9/08; F25C 1/00

(52) U.S. Cl. CPC B08B 9/0813; B08B 9/0808; F25C 1/00; B08B 2209/08; F25C 2500/08

(57) ABSTRACT

A method for cleaning an ice-making device includes obtaining a cleaning start instruction, and in response to the cleaning start instruction, injecting cleaning liquid into an ice-making cylinder of the ice-making device through a water inlet on the ice-making cylinder, and driving an ice-scraping screw in the ice-making cylinder to rotate to clean the ice-making device.

### CROSS-REFERENCE TO RELATED APPLICATION

This application is based on and claims priority to China Patent Application No. 202410873287.2, filed on Jun. 28, 2024, the entire contents of which are incorporated herein by reference.

### FIELD

The present disclosure relates to the technical field of electrical devices, and more particularly, to a method and an apparatus for cleaning an ice-making device, and an ice-making device.

### BACKGROUND

With people's increasing pursuit of a healthy diet and quality of life, the demand for ice-making devices is continuously growing. Nowadays, the ice-making devices are widely used in households, the catering industry, hotels, hospitals, and other places, to produce ice cubes for making cold food and beverages, cooling drinks, preserving food, and for medical purpose, and so on. However, during the long-term use of the ice-making device, due to issues such as water quality problems, impurities in the air, and microbial growth, dirt and bacteria are likely to accumulate inside an ice-making cylinder, which not only affects the ice-making efficiency but also pose a threat to the health of users.

The conventional method for cleaning the ice-making device usually requires manual disassembly of the ice-making cylinder and manual cleaning. It is time-consuming and labor-intensive, and improper operations may damage the internal structure of the ice-making device.

The above content is only used to assist in understanding the technical solution of the present disclosure and does not constitute an admission that the above content is the related art.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to clearly explain technical solutions in the embodiments of the present disclosure or in the related art, drawings used in the description of the embodiments or the related art are briefly described below. Obviously, based on these drawings, other drawings can be obtained by those skilled in the art without creative effort.

FIG. 1 is a schematic flowchart of a method for cleaning an ice-making device according to an embodiment of the present disclosure.

FIG. 2 is a schematic flowchart of a method for cleaning an ice-making device according to another embodiment of the present disclosure.

FIG. 3 is a schematic flowchart of a method for cleaning an ice-making device according to another embodiment of the present disclosure.

FIG. 4 is a schematic flowchart of a method for cleaning an ice-making device according to another embodiment of the present disclosure.

FIG. 5 is a schematic flowchart of a method for cleaning an ice-making device according to another embodiment of the present disclosure.

FIG. 6 is a schematic flowchart of a method for cleaning an ice-making device according to another embodiment of the present disclosure.

FIG. 7 is a schematic flowchart of a method for cleaning an ice-making device according to another embodiment of the present disclosure.

FIG. 8 is a schematic flowchart of a method for cleaning an ice-making device according to another embodiment of the present disclosure.

FIG. 9 is a schematic flowchart of a method for cleaning an ice-making device according to another embodiment of the present disclosure.

FIG. 10 is a schematic flowchart of a method for cleaning an ice-making device according to another embodiment of the present disclosure.

FIG. 11 is a schematic structural diagram of an ice-making device according to an embodiment of the present disclosure.

FIG. 12 is a schematic structural diagram of an ice-making device according to another embodiment of the present disclosure.

FIG. 13 is a schematic structural diagram of an ice-making device according to another embodiment of the present disclosure.

### REFERENCE NUMERALS

Explanation of the reference numerals in the accompanying drawings:

110, ice-making cylinder; 111, water inlet; 112, ice-scraping screw; 113, water outlet; 114, ice outlet; 210, water supply pipeline; 220, water supply device; 130, first valve; 240, second valve; 250, drainage pipeline; 260, water receiving device; 270, upper cover; 300, ice squeezing head; 410, compressor; 420, condenser; 430, throttle device; 440, evaporator; 441, evaporator first port; 442, evaporator second port; 450, third valve; 510, drive motor; 520, transmission mechanism.

Implementations of the objects, functional features, and advantages of the present disclosure will be further described in connection with the embodiments and with reference to the accompanying drawings.

### DETAILED DESCRIPTION

It should be understood that specific embodiments described herein are intended to explain the present disclosure only, rather than to limit the present disclosure.

In order to better understand the technical solution of the present disclosure, a detailed description will be given below in conjunction with the accompanying drawings and specific embodiments.

The main solution of the embodiments of the present disclosure is as follows. The ice-making device includes an ice-making cylinder 110. The ice-making cylinder 110 has a water inlet 111 formed thereon and has an ice-scraping screw 112 disposed in the ice-making cylinder 110. The method for cleaning the ice-making device includes: obtaining a cleaning start instruction; in response to the cleaning start instruction, injecting cleaning liquid into the ice-making cylinder 110 through the water inlet 111, and driving the ice-scraping screw 112 to rotate to clean the ice-making device.

In this embodiment, for convenience of description, the following description will be made with identifying an apparatus for cleaning the ice-making device as an execution body.

With people's increasing pursuit of a healthy diet and quality of life, the demand for ice-making devices is continuously growing. Currently, the ice-making devices are widely used in households, the catering industry, hotels, hospitals, and other places, to produce ice cubes for making cold food and beverages, cooling drinks, preserving food, and for medical purpose, and so on. However, during the long-term use of the ice-making device, due to issues such as water quality problems, impurities in the air, and microbial growth, dirt and bacteria are likely to accumulate inside the ice-making cylinder 110, which not only affects the ice-making efficiency but also pose a threat to the health of users.

The conventional method for cleaning the ice-making device usually requires manual disassembly of the ice-making cylinder 110 and manual cleaning. It is time-consuming and labor-intensive, and improper operations may damage the internal structure of the ice-making device.

Based on the above problems, the present disclosure provides a solution. In the technical solution of the present disclosure, the ice-making device includes the ice-making cylinder 110, the ice-making cylinder 110 has the water inlet 111 formed thereon and has the ice-scraping screw 112 disposed in the ice-making cylinder 110. The method for cleaning the ice-making device includes: obtaining the cleaning start instruction; then in response to the cleaning start instruction, injecting the cleaning liquid into the ice-making cylinder 110 through the water inlet 111, and driving the ice-scraping screw 112 to rotate; and discharging the wastewater in the ice-making cylinder 110 formed after cleaning by using the cleaning liquid after a predetermined duration, to clean the ice-making device. Through the structural design or the aforementioned method of the present disclosure, the ice-making device can be cleaned by injecting the cleaning liquid into the ice-making cylinder 110 and driving the ice-scraping screw 112 in the ice-making device to rotate without disassembling the ice-making device, enabling simple operation, enhancing the convenience of cleaning the ice-making device, and effectively avoiding problems such as dirt and bacteria contamination during the long-time use of the ice-making device.

It is to be noted that the execution body of the embodiment may be a computing service device, such as a tablet computer, a personal computer, a cellular phone, and the like, having functions of data processing, network communication, and program operation, or may be an electronic device, an apparatus for cleaning an ice-making device, and the like, capable of realizing the above functions. Hereinafter, this embodiment and the following embodiments will be described by taking the apparatus for cleaning the ice-making device as an example.

Based on this, according to an embodiment of the present disclosure, a method for cleaning an ice-making device is provided. Referring to FIG. 11, the ice-making device includes an ice-making cylinder 110. The ice-making cylinder 110 has a water inlet 111 formed thereon, and has the ice-scraping screw 112 disposed in the ice-making cylinder 110.

In this embodiment, the ice-making cylinder 110 defines a closed space for making ice cubes, and a temperature inside the ice-making cylinder 110 is reduced by a refrigeration system, allowing a liquid in the ice-making cylinder 110 to freeze into ice under the low-temperature environment. The refrigeration system may be a compression refrigeration system, a semiconductor refrigeration system, or any other type of refrigeration system, as long as the liquid in the ice-making cylinder 110 can freeze into ice. The water inlet 111 may be formed at a side wall, a top or a bottom of the ice-making cylinder 110, and is configured to inject liquid into the ice-making cylinder 110 to make ice or inject a cleaning liquid into the ice-making cylinder 110 to clean the ice-making device. In addition, a plurality of water inlets 111 may be provided, one or more of which is configured to only inject a liquid into the ice-making cylinder 110 to make ice, and the other is configured to inject the cleaning liquid into the ice-making cylinder 110 for cleaning. In this way, the ice-making and cleaning operations are more independent from each other, and the use efficiency of the ice-making device is improved. The ice-scraping screw 112 is located inside the ice-making cylinder 110, and includes a spiral scraper formed thereon. The scraper is configured to rotate under the drive of a motor, to detach ice cubes from an inner wall of the ice-making cylinder 110 and deliver the ice cubes for subsequent ice collection and pickup. The ice-scraping screw 112 may further be configured to assist in the circulation and stirring of the cleaning liquid in the ice-making cylinder 110, thereby achieving a cleaning effect.

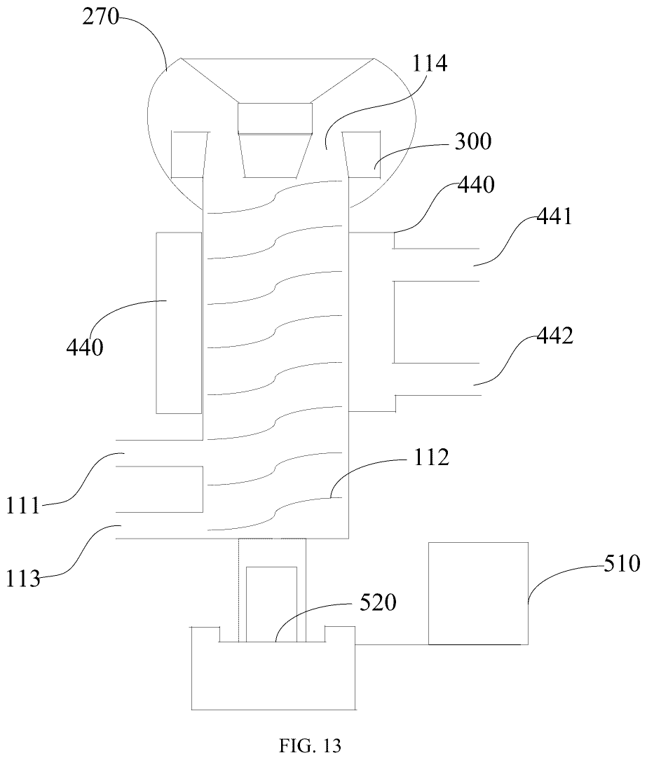

In a possible embodiment, referring to FIG. 13, the ice-making device further includes a drive motor 510 and a transmission mechanism 520. A driving shaft of the drive motor 510 is in transmission connection with the transmission mechanism 520. The transmission mechanism 520 is in transmission connection with the ice-scraping screw 112. In this embodiment, the transmission mechanism 520 may be a gear transmission mechanism 520, a chain transmission mechanism 520, a belt transmission mechanism 520, etc., as long as power transmission between the drive motor 510 and the ice-scraping screw 112 can be realized. The drive motor 510 drives the transmission mechanism 520 to move, to cause the ice-scraping screw 112 to rotate inside the ice-making cylinder 110, so as to detach the ice cubes from the inner wall of the ice-making cylinder 110 and deliver the ice cubes for subsequent ice collection and pickup, or to 112 assist the circulation and stirring of the cleaning liquid in the ice-making cylinder 110, thereby achieving the cleaning effect.

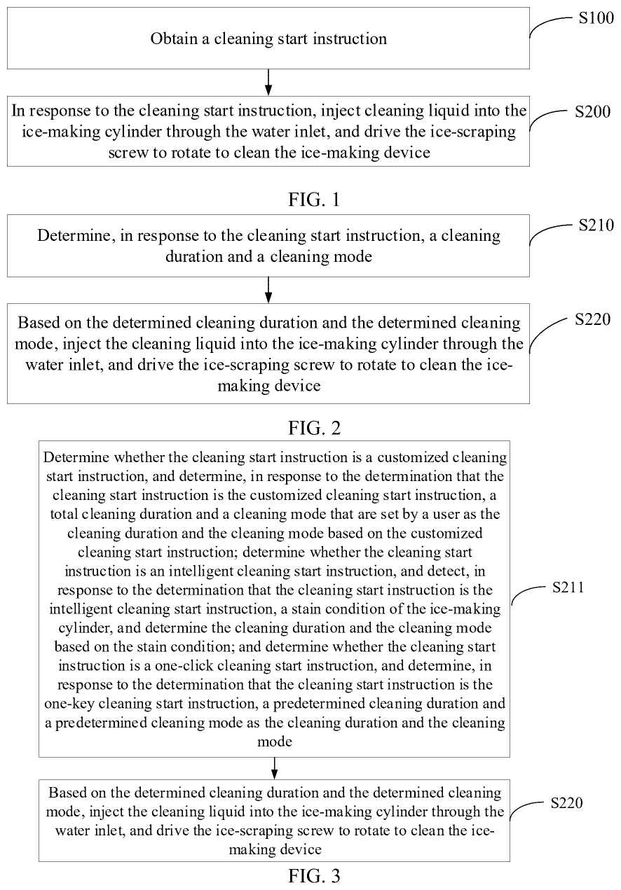

FIG. 1 is a schematic flowchart of a method for cleaning an ice-making device according to an embodiment of the present disclosure.

In this embodiment, the method for cleaning the ice-making device includes following operations.

At S100, a cleaning start instruction is obtained.

In this embodiment, the cleaning start instruction may be manually triggered by a user through an operation interface of the ice-making device, such as by pressing a cleaning key or touching a cleaning icon on a screen. The ice-making device may also receive a remote cleaning start instruction from a smartphone, a tablet computer, or other terminal devices via wireless communication. In addition, the cleaning start instruction may also automatically be triggered by a predetermined timing task or when a predetermined condition is met. The cleaning start instruction may also be automatically triggered based on determination on parameters such as water quality monitoring data and ice-making efficiency, to realize intelligent cleaning management of the ice-making device. Subsequent to the cleaning start instruction being triggered, the ice-making device obtains the cleaning start instruction to start executing a cleaning process.

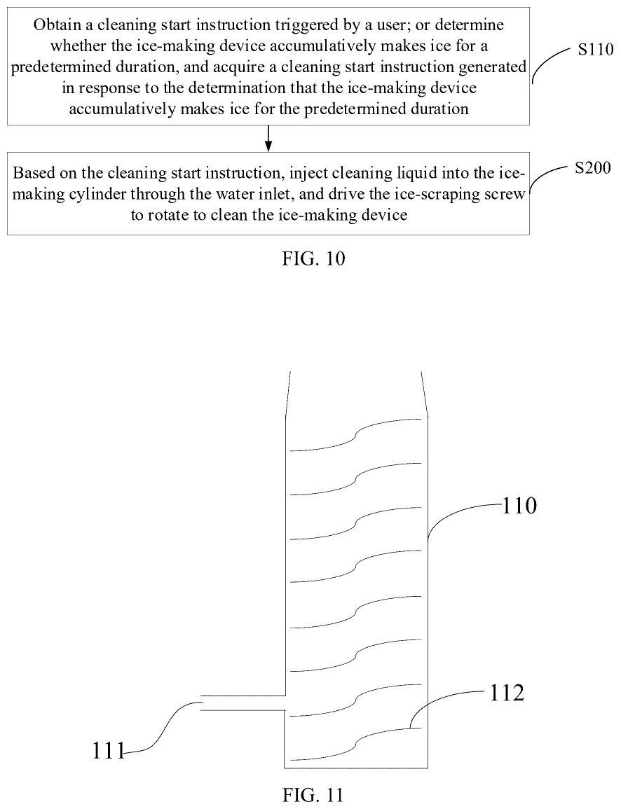

In a possible embodiment, referring to FIG. 10, operation S100 includes operation S110. At S110, a cleaning start instruction triggered by a user is obtained; or it is determined whether the ice-making device accumulatively makes ice for a predetermined duration, and a cleaning start instruction generated in response to the determination that the ice-making device accumulatively makes ice for the predetermined duration is obtained.

In this embodiment, the user may trigger the cleaning start instruction by touching or pressing a key corresponding to the cleaning start instruction on the ice-making device, or by means of a user interface (e.g., a cell phone APP, a touch screen, etc.) that is compatible with the apparatus for cleaning the ice-making device. When the user finds that the ice-making device is losing operation efficiency, the quality of ice cubes is decreasing, or regular maintenance is required, the user may select the cleaning operation to be performed through the user interface, and then the cleaning device can obtain the cleaning start instruction triggered by the user.

In this embodiment, the ice-making device may further be equipped with an intelligent monitoring module, which may include various sensors and counters such as a water quality monitoring sensor, a temperature monitoring sensor, an operation time counter, and the like. These modules may monitor parameters such as water quality, temperature, and operation duration of the ice-making device in real time. When these parameters reach a predetermined threshold, the intelligent monitoring module may automatically trigger the cleaning start instruction. In response to detecting that the ice-making device accumulatively makes ice for the predetermined duration (e.g., continuously operates for a predetermined duration, or the accumulated number of ice-making times reaches a predetermined number), the water quality parameter exceeds a predetermined threshold, or the ice-making efficiency significantly decreases, the intelligent monitoring module automatically triggers the cleaning start instruction, allowing the cleaning device to obtain the cleaning start instruction to start executing the cleaning process. In this way, the timeliness of cleaning the ice-making device can be ensured, and the operation burden of the user can be reduced to improve the user experience.

In this embodiment, different cleaning start instructions are set corresponding to different degrees of dirt and bacterial residues of the ice-making device, allowing targeted cleaning for different degrees of dirt and bacterial residues of the ice-making device to be realized. For example, in response to detecting a slight contamination of the ice-making device, a mild cleaning start instruction may be triggered to perform a shorter cleaning process or a lower rotation speed of the ice-scraping screw 112; whereas in response to detecting a severe contamination, a deep cleaning instruction may be triggered to perform a longer cleaning process with a higher rotation speed of the ice-scraping screw 112 to ensure complete removal of the dirt and bacterial residues.

At S200, in response to the cleaning start instruction, cleaning liquid is injected into the ice-making cylinder 110 through the water inlet 111, and the ice-scraping screw 112 is driven to rotate to clean the ice-making device.

In this embodiment, the cleaning liquid may be a cleaning agent special for the ice-making device, or may be ordinary water or other nontoxic and non-corrosive liquids. In addition, the cleaning liquid may further be selected based on factors such as an internal material, dirt type, and cleaning degree of the ice-making device to achieve optimal cleaning effect. Injection of the cleaning liquid may be achieved by controlling a solenoid valve, a water pump, etc., to ensure that the cleaning liquid enters the ice-making cylinder 110 evenly and sufficiently. Subsequent to the cleaning liquid being injected into the ice-making cylinder 110, the ice-scraping screw 112 starts to rotate under the driving of the motor. When the spiral scraper is rotating, the ice cubes remaining in the ice-making cylinder 110 can be detached and the cleaning liquid can be stirred. In this way, the cleaning liquid flows in the ice-making cylinder 110 and fully contacts with the dirt on the inner wall of the ice-making cylinder 110 and the ice-scraping screw 112, thereby enhancing scouring force of the cleaning liquid, and effectively removing dirt and bacteria.

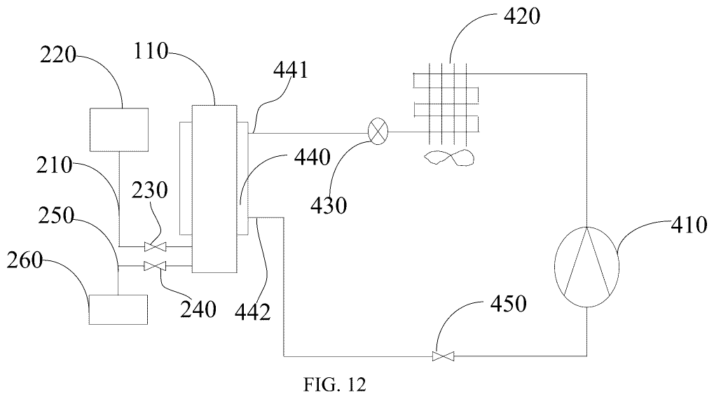

In a possible embodiment, referring to FIG. 12, the water inlet 111 is connected to a water supply device 220 through a water supply pipeline 210. The ice-making device further includes a first valve 230 disposed at the water supply pipeline 210.

In this embodiment, the water supply device 220 may be a tap water system, a water tank, a reservoir, or any other device capable of providing the cleaning liquid. The first valve 230 is disposed at the water supply pipeline 210 and is configured to control an inflow of the cleaning liquid. The first valve 230 may be a solenoid valve, a mechanical valve, or any other device capable of controlling a flow of liquid. By controlling opening and closing of the first valve 230, it is possible to control the water supply device 220 to supply the cleaning liquid to the ice-making device, to ensure that the cleaning liquid can accurately and timely enter the ice-making cylinder 110 when cleaning is required. When the ice-making device needs to be cleaned, the first valve 230 is opened to allow the cleaning liquid to flow into the ice-making cylinder 110 through the water supply pipeline 210. When the cleaning liquid reaches a predetermined liquid level in the ice-making cylinder 110, the first valve 230 is closed to stop the inflow of the cleaning liquid, and to prevent the backflow of the cleaning liquid when the ice-scraping screw 112 is rotating to clean the ice-making device.

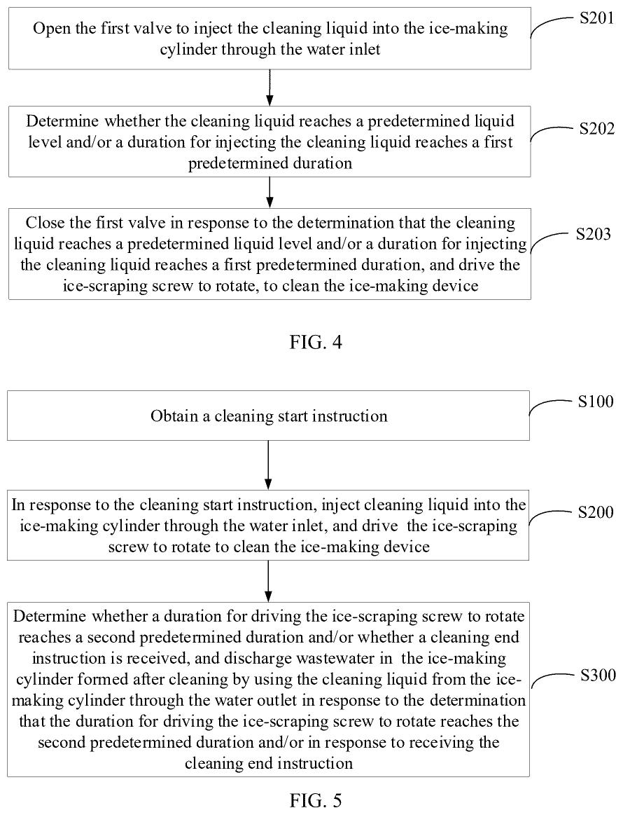

In a possible embodiment, referring to FIG. 4, S200 includes following operations.

At S201, the first valve 230 is opened for injecting the cleaning liquid into the ice-making cylinder 110 through the water inlet 111.

In this embodiment, in response to receiving the cleaning start instruction, the first valve 230 is opened, allowing the cleaning liquid to flow into the ice-making cylinder 110 through the water supply pipeline 210.

At S202, it is determined whether the cleaning liquid reaches a predetermined liquid level and/or a duration for injecting the cleaning liquid reaches a first predetermined duration.

At S203, the first valve 230 is closed in response to the determination that the cleaning liquid reaches the predetermined liquid level and/or the duration for injecting the cleaning liquid reaches a first predetermined duration, and the ice-scraping screw 112 is driven to rotate to clean the ice-making device.

In this embodiment, the predetermined liquid level and the first predetermined duration may be set based on factors such as the specific size of the ice-making device, cleaning requirements, and properties of the cleaning liquid, to ensure that the cleaning liquid can fully cover the inner wall of the ice-making cylinder 110, thereby ensuring the cleaning effect without causing waste of the cleaning liquid. When the cleaning liquid reaches the predetermined liquid level or the duration for injecting the cleaning liquid reaches the first predetermined duration, the first valve 230 is controlled to be closed, and the ice-scraping screw 112 is controlled to rotate. When the ice-scraping screw 112 starts to rotate, the ice-scraping screw 112 operates based on cleaning parameters in a cleaning mode corresponding to the cleaning start instruction. The parameters in the cleaning mode include a rotation direction of the ice-scraping screw 112, a rotation mode of the ice-scraping screw 112, a rotation speed of the ice-scraping screw 112, the number of cleanings, and when a plurality of cleanings are to be performed, a duration of each of the plurality of cleanings. The rotation of the ice-scraping screw 112 evenly distributes the cleaning liquid on the inner wall of the ice-making cylinder 110 and on the ice-scraping screw 112, while helping to remove stubborn dirt and bacteria.

In a possible embodiment, referring to FIG. 2, S200 includes following operations.

At S210, a cleaning duration and a cleaning mode are determined in response to the cleaning start instruction.

In this embodiment, since different cleaning start instructions are set corresponding to different degrees of dirt and bacterial residues of the ice-making device, targeted cleaning for the different degrees of dirt and bacterial residues of the ice-making device can be realized. Therefore, a cleaning duration and a cleaning mode may be determined based on a type of the cleaning start instruction. For example, when the user selects a basic cleaning mode through the user interface, the cleaning duration may be short, such as five minutes, ten minutes, etc., and the specific cleaning duration is not limited herein. Meanwhile, the concentration of the cleaning liquid and the rotation speed of the ice-scraping screw 112 may be relatively low. When the user selects a deep cleaning mode, the cleaning duration may be longer, and the concentration of the cleaning liquid and the rotation speed of the ice-scraping screw 112 may be correspondingly increased to ensure the cleaning effect. In addition, when the cleaning start instruction is automatically triggered, different cleaning start instructions may be triggered based on a duration since the last cleaning, the ice-making duration, or a monitored contamination degree of the ice-making device, and the cleaning duration and the cleaning mode are determined in response to the triggered cleaning start instruction.

In a possible embodiment, referring to FIG. 3, operation S210 includes operation S211. At S211, it is determined whether the cleaning start instruction is a customized cleaning start instruction, and in response to the determination that the cleaning start instruction is the customized cleaning start instruction, a total cleaning duration and a cleaning mode that are set by a user are determined as the cleaning duration and the cleaning mode based on the customized cleaning start instruction; it is determined whether the cleaning start instruction is an intelligent cleaning start instruction, and in response to the determination that the cleaning start instruction is the intelligent cleaning start instruction, a stain condition of the ice-making cylinder is detected, and the cleaning duration and the cleaning mode are determined based on the stain condition; it is determined whether the cleaning start instruction is a one-click cleaning start instruction, and in response to the determination that the cleaning start instruction is the one-click cleaning start instruction, a predetermined cleaning duration and a predetermined cleaning mode are determined as the cleaning duration and the cleaning mode.

In this embodiment, the cleaning start instruction may include the customized cleaning start instruction, the intelligent cleaning start instruction, and the one-click cleaning start instruction. For the customized cleaning start instruction, the user may set a total cleaning duration and a cleaning mode through the user interface (such as an operation panel set on the ice-making device, a mobile phone APP, a touch screen, etc.) based on the user's own needs and actual conditions. The total cleaning duration may be set based on the contamination degree of the ice-making device and a time arrangement of the user, and the cleaning mode may be selected based on parameters such as the type and concentration of the cleaning liquid and the rotation speed of the ice-scraping screw 112, to meet different cleaning requirements.

In this embodiment, in response to selecting the intelligent cleaning start instruction, the ice-making device automatically detects the stain condition of the ice-making cylinder 110, and intelligently determine the cleaning duration and the cleaning mode based on the stain condition. To realize this function, the ice-making device may be equipped with a stain detection sensor, which is capable of detecting a degree of stain on the inner wall of the ice-making cylinder 110 and the ice-scraping screw 112 in real time, and feedbacking detection data to a control system. The control system automatically selects the appropriate cleaning duration and the appropriate cleaning mode based on the detected staining degree, thus ensuring optimal cleaning effect.

In this embodiment, the one-click cleaning start instruction provides the user with a quick and simple cleaning mode. When the user selects the one-click cleaning start instruction, the ice-making device is cleaned based on the predetermined cleaning duration and the predetermined cleaning mode. The predetermined cleaning duration and the predetermined cleaning mode may be set at the factory, or may be set by the user based on the actual usage habits of the user. Meanwhile, the predetermined cleaning duration and the predetermined cleaning mode may be set based on the general usage conditions and cleaning requirements of the ice-making device, which is suitable for most situations. In the cleaning mode corresponding to the one-click cleaning start instruction, the user only needs to trigger the one-click cleaning start instruction without any setting, and the ice-making device will automatically complete the cleaning process.

In this embodiment, subsequent to the cleaning duration and the cleaning mode being determined, the ice-making device will perform automatic cleaning based on the corresponding cleaning parameters. During the cleaning process, the ice-scraping screw 112 is driven by the motor to rotate, and the spiral scraper strips off the ice cubes remaining in the ice-making cylinder 110, and stirs the cleaning liquid to make the cleaning liquid fully contact with the stain on the inner wall of the ice-making cylinder 110 and the ice-scraping screw 112. In this case, the scouring force of the cleaning fluid will help remove stubborn dirt and bacteria, ensuring the cleanliness and sanitary status of the ice-making device.

In this embodiment, by providing multiple cleaning start instructions and intelligent cleaning parameter settings, the ice-making device can be cleaned in a more flexible and efficient manner, to ensure that the cleanliness and sanitary status of the ice-making device meet the requirements of the user.

At S220, the ice-scraping screw 112 is controlled to rotate in the cleaning liquid at a corresponding rotation speed based on the determined cleaning duration and the determined cleaning mode, to clean the ice-making device.

In this embodiment, based on the cleaning duration and the cleaning mode determined by the cleaning start instruction, the control system precisely adjusts the rotation speed of the ice-scraping screw 112 in the cleaning liquid. When the cleaning mode is the deep cleaning mode, the rotation speed of the ice-scraping screw 112 may be increased to better detach and stir the ice cubes and the cleaning liquid, thereby improving the cleaning effect. For a specific cleaning requirement, for example, only a certain area of the ice-making cylinder 110 needs to be cleaned, the control system may adjust the rotation direction or the rotation mode of the ice-scraping screw 112 to ensure that the cleaning liquid covers the area to be cleaned.

In a possible embodiment, each cleaning mode includes setting of any one or more of the following parameters: a liquid level to be reached by the cleaning liquid injected into the ice-making cylinder 110; a rotation direction of the ice-scraping screw 112; a rotation mode of the ice-scraping screw 112; a rotation speed of the ice-scraping screw 112; the number of cleanings; and when a plurality of cleanings are to be performed, a duration of each of the plurality of cleanings.

In this embodiment, the liquid level to be reached by the cleaning liquid injected into the ice-making cylinder 110 directly affects the cleaning effect and utilization efficiency of the cleaning liquid. Generally, the liquid level is selected in consideration of factors such as a volume of the ice-making cylinder 110, the concentration of the cleaning liquid, and a cleaning requirement. When the liquid level of the cleaning liquid is too low, the inner wall of the ice-making cylinder 110 and the ice-scraping screw 112 cannot be fully covered, resulting in a poor cleaning effect. When the liquid level is too high, although the cleaning effect can be improved, the cleaning fluid may be wasted, resulting in increased cleaning costs. Therefore, when determining the cleaning mode, the control system intelligently selects an appropriate liquid level of the cleaning fluid depending on the type of cleaning start instruction and the cleaning requirements. For example, a lower liquid level may be selected in the basic cleaning mode, while a higher liquid level may be selected in the deep cleaning mode to improve the cleaning effect. In addition, the control system may further dynamically adjust the liquid level of the cleaning liquid based on a real-time stain condition of the ice-making cylinder 110 to ensure the optimal cleaning effect.

In this embodiment, the rotation direction of the ice-scraping screw 112 includes a clockwise rotation and a counterclockwise rotation. Different rotation directions can cause the scraper to generate different water flows and scouring forces in the ice-making cylinder 110, thereby adapting to different cleaning requirements. For example, the counterclockwise rotation can cause the scraper to create an upward liquid flow within the ice-making cylinder 110 to help scour out dirt and bacteria, while the clockwise rotation can create a downward liquid flow to help drain the cleaning liquid along with the dirt.

In this embodiment, the rotation mode of the ice-scraping screw 112 may include a continuous rotation mode, an intermittent rotation mode, or a pulse rotation mode. The continuous rotation mode is suitable for a situation where a long time and continuous cleaning is required, and can ensure that the cleaning liquid fully contacts with the dirt on the inner wall of the ice-making cylinder 110 and the ice-scraping screw 112, to improve the cleaning effect. The intermittent rotation mode is suitable for a situation where an interval is needed in the cleaning process, which can reduce wear of the ice-scraping screw 112 and reduce energy consumption. The pulse rotation mode involves a fast and short rotation to produce a strong scouring force, and is suitable for a situation where stubborn dirt needs to be rapidly removed.

In this embodiment, the different rotation speeds of the ice-scraping screw 112 further have significant impact on the cleaning effect. A higher rotation speed can generate a stronger scouring force and stirring effect, which helps to detach the ice cubes remaining in the ice-making cylinder 110, and promotes sufficient contact between the cleaning liquid and the dirt, thereby improving the cleaning efficiency. However, an excessively high rotation speed can further cause problems such as splashing of the cleaning liquid, increased energy consumption, and increased wear of the ice-scraping screw 112. The control system may intelligently select an appropriate rotation speed for the ice-scraping screw 112 based on the type of the cleaning start instruction, the cleaning requirement, and the real-time stain condition of the ice-making cylinder 110. For example, in the basic cleaning mode, a lower rotation speed may be selected to save energy, while in the deep cleaning mode, a higher rotation speed may be selected to improve the cleaning effect. In addition, the control system may further dynamically adjust the rotation speed of the ice-scraping screw 112 based on real-time feedback in the cleaning process, to ensure the optimal cleaning effect.

In this embodiment, the cleaning mode may further include the number of cleanings. It will be appreciated that an appropriate number of cleanings can ensure that the ice-making device is adequately cleaned, thereby removing residual dirt and bacteria, and improving ice-making quality and sanitary status. However, excessive number of cleanings will not only increase energy consumption and cleaning costs, but can also cause unnecessary wear and tear to the ice-making device. The control system may intelligently set the number of cleanings based on the type of the cleaning start instruction and the cleaning requirements, such as one, two or three cleanings, and the specific number of cleanings may be adjusted based on an actual use condition of the user and the staining degree of the ice-making device, which is not limited herein. For example, in the basic cleaning mode, a smaller number may be selected to save energy and cleaning costs, while in the deep cleaning mode, a greater number may be selected to ensure the cleaning effect. In addition, the control system may also dynamically adjust the number of cleanings based on the real-time stain condition of the ice-making device. In the case of heavy stains, the number of cleanings may be appropriately increased to improve the cleaning effect; and in the case of light stains, the number of cleanings may be reduced to save energy consumption and cleaning costs.

In this embodiment, when plurality of cleanings are to be performed, the cleaning mode may further include the duration of each of the plurality of cleanings. It will be appreciated that a proper cleaning duration ensures that the cleaning liquid is in sufficient contact with the dirt on the inner wall of the ice-making device and the ice-scraping screw 112, thereby improving the cleaning effect. However, a too-long cleaning duration may lead to increased energy consumption and waste of the cleaning liquid, while a too-short cleaning duration may not be able to adequately clean the ice-making device, resulting in a poor cleaning effect. Therefore, when setting the duration of each cleaning, it is necessary to comprehensively consider factors such as cleaning requirements, the concentration and cleanliness of the cleaning liquid, the structure and material of the ice-making device, etc.

The control system may intelligently set the duration of each cleaning based on the type of the cleaning start instruction and cleaning requirements. For example, in the basic cleaning mode, a shorter cleaning duration may be selected, while in the deep cleaning mode, a longer cleaning duration may be selected to ensure the cleaning effect. In addition, the control system may also dynamically adjust the duration of each cleaning based on the real-time stain condition of the ice-making device. In the case of heavy stains, the duration of each cleaning may be appropriately extended to improve the cleaning effect; in the case of light stains, the duration of each cleaning may be shortened to save energy consumption and cleaning costs.

In this embodiment, parameters, such as the liquid level to be reached by the cleaning liquid injected into the ice-making cylinder 110, the rotation direction of the ice-scraping screw 112, the rotation mode of the ice-scraping screw 112, the rotation speed of the ice-scraping screw 112, the number of cleanings, and the duration of each cleaning when the plurality of cleanings are to be performed, are determined by the cleaning mode. Therefore, the apparatus for cleaning the ice-making device performs the cleaning based on the parameters corresponding to the cleaning mode, thereby adapting to different cleaning requirements and improving the cleaning effect and the cleaning efficiency.

In a possible embodiment, referring to FIG. 5 and FIG. 13, the ice-making cylinder 110 further has a water outlet 113 formed thereon. The method for cleaning the ice-making device further includes operation S300. At S300, it is determined whether a duration for driving the ice-scraping screw to rotate reaches a second predetermined duration and/or whether a cleaning end instruction is received, and wastewater in the ice-making cylinder 110 formed after cleaning by using the cleaning liquid is discharged from the ice-making cylinder 110 through the water outlet 113 in response to the determination that the duration for driving the ice-scraping screw 112 to rotate reaches the second predetermined duration and/or in response to receiving the cleaning end instruction.

In this embodiment, the water outlet 113 may be formed at or formed close to a bottom of the ice-making cylinder 110, to facilitate a smooth discharge of the wastewater. When the ice-scraping screw 112 is rotating, the cleaning liquid interacts with the dirt and bacteria on the inner wall of the ice-making cylinder 110 and the ice-scraping screw 112 to form wastewater. The second predetermined duration may be set based on the staining degree of the ice-making device and requirements of the cleaning effect. When the duration for driving the ice-scraping screw 112 to rotate reaches the second predetermined duration, it can be considered that the cleaning process has achieved a desired effect, and in this case, the wastewater formed in the cleaning process is discharged out of the ice-making cylinder 110 through the water outlet 113, to perform a subsequent ice-making operation or further cleaning.

In this embodiment, when a special situation occurs in the process of cleaning the ice-making device, such as the user needs to end the cleaning in advance, or the system detects that the cleaning liquid is insufficient, regardless of whether the duration for driving the ice-scraping screw 112 to rotate reaches the second predetermined duration, the system immediately stop the rotation of the ice-scraping screw 112, and discharge the wastewater out of the ice-making cylinder 110 through the water outlet 113.

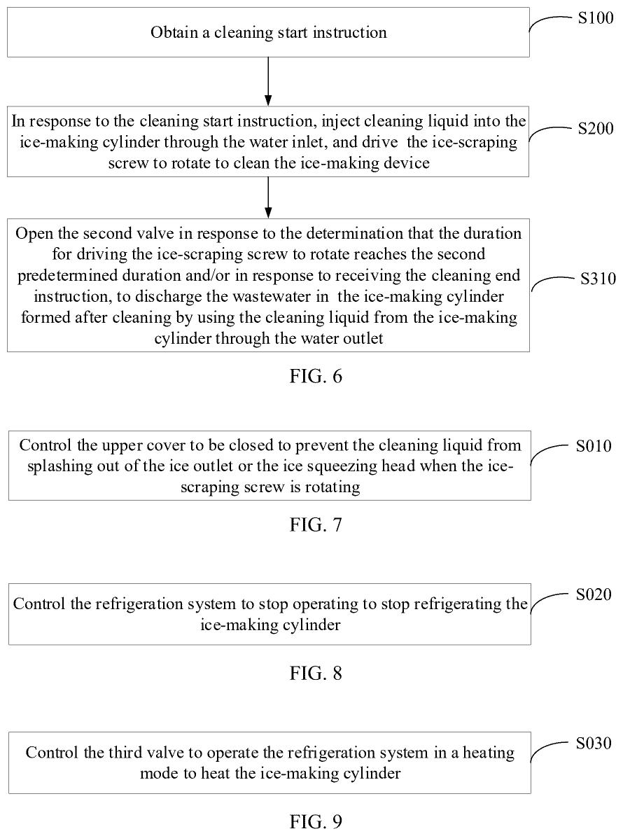

In a possible embodiment, referring to FIG. 6 and FIG. 12, the ice-making device further includes a second valve 240 disposed at the water outlet 113. Operation S300 includes operation S310. At S310, the second valve 240 is opened in response to the determination that the duration for driving the ice-scraping screw 112 to rotate reaches the second predetermined duration and/or in response to receiving the cleaning end instruction, to discharge the wastewater in the ice-making cylinder 110 formed after cleaning by using the cleaning liquid from the ice-making cylinder 110 through the water outlet 113.

In this embodiment, the second valve 240 may be a solenoid valve, a mechanical valve, or any other device capable of controlling the on and off of the liquid flow. The second valve 240 can ensure that wastewater can be smoothly discharged from the water outlet 113 when wastewater is required to be discharged, while avoiding accidental outflow of the wastewater or the cleaning liquid when the wastewater is not required to be discharged.

In this embodiment, the water outlet 113 is connected to a water receiving device 260 through a drainage pipeline 250. The second valve 240 is disposed at the drainage pipeline 250. In this embodiment, the water receiving device 260 may include a water collecting tray or a wastewater collecting bucket configured to collect wastewater discharged from the water outlet 113. In response to the determination that the duration for driving the ice-scraping screw 112 to rotate reaches the second predetermined duration or in response to receiving the cleaning end instruction, the second valve 240 is opened, and the wastewater flows into the water receiving device 260 through the drainage pipeline 250, thereby realizing effective collection and discharge of the wastewater, facilitating treatment of the wastewater, and avoiding possible pollution problems caused by a direct discharge of the wastewater into the environment.

In this embodiment, the water collecting tray of the water receiving device 260 is detachably connected to the drainage pipeline 250, which is convenient for the user to clean and replace. The wastewater collecting bucket may be provided with a handle, which is convenient for the user to lift and pour the wastewater. Meanwhile, to prevent the wastewater from blocking the drainage pipeline 250, a filter screen or other anti-blocking device may be further arranged in the drainage pipeline 250 to ensure that the wastewater can smoothly flow into the water receiving device 260. Providing the second valve 240 in the drainage pipeline 250 further ensures that the drainage pipeline 250 will not be accidentally opened in the cleaning process and result in leakage of the cleaning fluid or the wastewater. In addition, by controlling the opening and closing of the second valve 240, it is possible to precisely control the drainage process and avoid waste of water resources and environmental pollution.

In this embodiment, in response to the determination that the duration for driving the ice-scraping screw 112 to rotate reaches the second predetermined duration or in response to receiving the cleaning end instruction, the control system may trigger the opening of the second valve 240. With the opening of the second valve 240, the wastewater in the ice-making cylinder 110 flows out through the water outlet 113 under the action of gravity and/or the second valve 240, thereby completing the discharge of the cleaning wastewater.

In this embodiment, after the wastewater is discharged, the ice-making device closes the second valve 240, to prevent the residual cleaning liquid or the liquid used for making ice in the ice-making cylinder 110 from flowing out, or for the ice-making device to start a new ice-making cycle or a further cleaning process based on needs, to ensure that the ice-making device can be in a normal operation state.

In a possible embodiment, referring to FIG. 13, the ice-making cylinder 110 further includes an ice outlet 114, and the ice-making device further includes an ice squeezing head 300 detachably mounted at the ice outlet 114. The method for cleaning the ice-making device further includes: determining whether the ice squeezing head is mounted at the ice outlet; and determining the cleaning mode as a first cleaning mode in response to the determination that the ice squeezing head 300 is mounted at the ice outlet 114, or determining the cleaning mode as a second cleaning mode in response to the determination that the ice squeezing head 300 is not mounted at the ice outlet 114. The first cleaning mode and the second cleaning mode are different in at least one of the liquid level to be reached by the cleaning liquid injected into the ice-making cylinder 110 or the rotation speed of the ice-scraping screw 112.

In this embodiment, the ice outlet 114 is an opening on the ice-making cylinder 110 configured to take out ice cubes. The ice squeezing head 300 is detachably mounted at the ice outlet 114, and is configured to squeeze an ice cube from the ice outlet to cause the ice cube to have a certain shape. In this way, the shape of ice cubes can be changed by the ice squeezing head 300 based on needs, to meet different requirements of actual use.

In this embodiment, the control system determines whether the ice squeezing head is mounted at the ice outlet; in response to the determination that the ice squeezing head 300 is mounted at the ice outlet 114, the control system determines the cleaning mode as the first cleaning mode. In the first cleaning mode, the control system performs a cleaning operation based on predetermined parameters, such as the liquid level of the cleaning liquid, the rotation speed of the ice-scraping screw 112, etc. Due to the presence of the ice squeezing head 300, the cleaning liquid needs to cover part of a surface of the ice squeezing head 300, and thus more cleaning liquid needs to be injected to achieve the desired cleaning effect. In this case, the rotation speed of the ice-scraping screw 112 may be adjusted accordingly to ensure that the surface of the ice squeezing head 300 and the inner wall of the ice-making cylinder 110 are adequately scoured in the cleaning process.

In this embodiment, in the first cleaning mode, the cleaning liquid is injected into the ice-making cylinder 110 to enable the cleaning liquid level to reach a first predetermined liquid level, and the ice-scraping screw 112 is driven to rotate at a first predetermined speed.

In this embodiment, the first predetermined liquid level is set based on the size of the ice squeezing head 300, the volume of the ice-making cylinder 110, and the properties of the cleaning liquid, to ensure that the cleaning liquid can cover the surface of the ice squeezing head 300 and the inner wall of the ice-making cylinder 110, thereby achieving the optimal cleaning effect. In addition, the first predetermined speed is determined based on a viscosity of the cleaning liquid, a material of the ice-making cylinder 110, and a design of the ice-scraping screw 112, to ensure that the ice-scraping screw 112 generates sufficient scouring force when the ice-scraping screw 112 is rotating to remove dirt and bacteria.

In this embodiment, in the second cleaning mode, the cleaning liquid is injected into the ice-making cylinder 110 to enable the cleaning liquid level to reach a second predetermined level, and the ice-scraping screw 112 is driven to rotate at a second predetermined speed.

In this embodiment, in response to the determination that the ice squeezing head 300 is not mounted at the ice outlet 114, the control system determines the cleaning mode as the second cleaning mode. In the second cleaning mode, since there is no ice squeezing head 300, the cleaning liquid only needs to cover the inner wall of the ice-making cylinder 110, and thus the second predetermined liquid level is lower than the first predetermined liquid level. In this case, the second predetermined speed is also lower than the first predetermined speed to adapt to the cleaning requirement when there is no ice squeezing head 300.

In the method for cleaning the ice-making device according to this embodiment, different cleaning modes are determined based on a mounting state of the ice squeezing head 300, and the liquid level of the cleaning liquid and the rotation speed of the ice-scraping screw 112 are adjusted accordingly. Thus, it is possible to ensure that the ice squeezing head 300 can be cleaned at the same time when the ice squeezing head 300 is mounted at the ice outlet 114, further enhancing the convenience of cleaning the ice-making device. In this case, since different cleaning modes and cleaning parameters are adopted to clean the ice-making device when the ice squeezing head 300 is mounted at the ice outlet 114 and when the ice squeezing head 300 is not mounted at the ice outlet 114, respectively, unnecessary cleaning liquid consumption and energy waste can be reduced, and cleaning efficiency can be improved while meeting predetermined cleaning requirements.

In a possible embodiment, the ice-making device further includes an upper cover 270 movably disposed at the ice outlet 114. Referring to FIG. 7, prior to driving the ice-scraping screw 112 to rotate, the method further includes operation S010. At S010, the upper cover 270 is controlled to be closed to prevent the cleaning liquid from splashing out of the ice outlet 114 or the ice squeezing head 300 when the ice-scraping screw 112 is rotating.

In this embodiment, the upper cover 270 may include a sealable panel or a sealing hood configured to close the ice outlet 114 in the cleaning process to prevent the cleaning liquid or the wastewater in the ice-making cylinder 110 formed after cleaning by using the cleaning liquid from splashing out. In this embodiment, the upper cover 270 is also adapted to the ice squeezing head 300, to ensure that the ice squeezing head 300 can be sealed when the ice squeezing head 300 is mounted at the ice outlet 114, thereby preventing the cleaning liquid or the wastewater from splashing out of the ice squeezing head 300. Before the ice-scraping screw 112 starts rotating, the ice-making device controls the upper cover 270 to be closed, ensuring safety and cleanliness of the cleaning process. A sealing effect can be further enhanced by providing a sealing structure, such as a rubber or silicone gasket, between the upper cover 270 and the ice outlet 114. A hinged connection, sliding connection, or other movable connection between the upper cover 270 and the ice-making cylinder 110 allows the upper cover 270 to be easily opened and closed. When the ice-making cylinder 110 needs to be cleaned, the upper cover 270 can be automatically closed by a driving device such as a motor or a cylinder, thereby preventing the cleaning liquid from spilling out of the ice outlet 114 or the ice squeezing head 300 when the ice-scraping screw 112 is rotating. Subsequent to controlling the upper cover 270 to be closed, the ice-scraping screw 112 starts rotating. In this case, due to the presence of the upper cover 270, the cleaning liquid or the wastewater in the ice-making cylinder 110 formed after cleaning by using the cleaning liquid is limited inside the ice-making cylinder 110, which ensures that the cleaning process is performed smoothly.

In a possible embodiment, the ice-making device includes a refrigeration system. The refrigeration system includes a compressor 410, a condenser 420, an evaporator 440, and a throttle device 430. The compressor 410, the condenser 420, the throttle device 430, and the evaporator 440 are sequentially in communication with each other to form a circulation loop. The evaporator 440 is arranged around the ice-making cylinder 110. Referring to FIG. 8, prior to driving the ice-scraping screw 112 to rotate, the method further includes operation S020. At S020, the refrigeration system is controlled to stop operating to stop refrigerating the ice-making cylinder 110.

In this embodiment, the evaporator 440 includes an evaporator first port 441 and an evaporator second port 442, and the evaporator first port 441 is in communication with the evaporator second port 442. When the ice-making device needs to operate to make ice, the refrigeration system starts. A refrigerant is compressed into a high-temperature and high-pressure gas by the compressor 410, converted into a high-pressure liquid after being refrigerated by the condenser 420, then turns to a low-temperature and low-pressure refrigerant liquid by decompression through the throttle device 430, and finally enters the evaporator 440 through the evaporator first port 441 and absorbs heat and evaporates into a refrigerant gas in the evaporator 440, to realize a refrigeration effect. After the refrigeration is completed, the refrigerant gas flows out of the evaporator second port 442 and is sucked into the compressor 410 again. The above processes are performed cyclically to continuously refrigerate the ice-making cylinder 110.

It should be understood that while cleaning the ice-making device, turning on an ice-making function of the ice-making device will cause a temperature of the cleaning liquid to drop rapidly, affecting the cleaning effect, and can even cause the cleaning liquid to freeze to block the cleaning pipeline or the ice-making cylinder 110. Therefore, prior to the cleaning operation, the refrigeration system needs to be stopped to ensure that the cleaning process takes place at a normal temperature or at a higher temperature.

In this embodiment, prior to driving the ice-scraping screw 112 to rotate, the refrigeration system is controlled to stop operating to stop refrigerating the ice-making cylinder 110. In an embodiment, prior to driving the ice-scraping screw 112 to rotate, the refrigeration system sends a signal to a controller of the refrigeration system, and the controller cuts off power to the compressor 410 to stop the compressor 410, thereby stopping the refrigeration cycle. In this case, other components of the refrigeration system, such as the condenser 420, the throttle device 430, and the evaporator 440, will also stop operating accordingly. When the refrigeration system stops operating, the evaporator 440 stops absorbing heat from the ice-making cylinder 110, thereby preventing freezing of the cleaning liquid due to low temperature or excessive low temperature inside the ice-making cylinder 110 in the cleaning process, ensuring fluidity of the cleaning liquid and cleaning effect, and further contributing to prolonging the service life of the ice-making cylinder 110 and the refrigeration system.

In a possible embodiment, the circulation loop is provided with a third valve 450 configured to control a circulation direction of the circulation loop. Referring to FIG. 9, prior to driving the ice-scraping screw 112 to rotate, the method further includes operation S030. At S030, the third valve is controlled to operate the refrigeration system in a heating mode to heat the ice-making cylinder.

In this embodiment, the third valve 450 may be a reversing valve, a three-way valve, or any other valve capable of realizing circulation loop reversing. By controlling the third valve 450, the third valve 450 controls the circulation direction of the circulation loop and adjust the operation mode of the refrigeration system, to allow the refrigeration system to operate in a refrigeration mode or the heating mode. In an embodiment, a circulation direction of a refrigerant in the circulation loop of the refrigeration system may be changed by the third valve 450. For example, the evaporator 440 that absorbs heat from the ice-making cylinder 110 in the refrigeration mode can be switched to a heat source that releases heat to the ice-making cylinder 110 in the heating mode by the third valve 450, thereby heating the ice-making cylinder 110 to help the cleaning liquid to better dissolve and to scour dirt and bacteria on the inner wall of ice-making cylinder 110, to improve the cleaning effect. In this embodiment, through the third valve 450, the refrigeration system performs both a function of refrigerating the ice-making cylinder in an ice-making process of the ice-making device and a function of heating the ice-making cylinder in a cleaning process of the ice-making device without an additional heating device, reducing the costs of the ice-making device, and improving the integration and reliability of the ice-making device.

In this embodiment, in a heating process, the ice-making device can control a heating duration and a temperature to ensure that a temperature of the ice-making cylinder 110 is gradually increased, but not too high to avoid damaging the ice-making cylinder 110. After heating, the refrigeration system sends a signal to the controller of the refrigeration system. The controller cuts off the power to the compressor 410 to stop the compressor 410, thereby stopping the refrigeration cycle. In this case, other components of the refrigeration system, such as the condenser 420, the throttle device 430, and the evaporator 440, also stop operating accordingly. In this way, since the temperature of the ice-making cylinder 110 has increased, the cleaning liquid can better perform its cleaning effect to remove stubborn dirt and bacteria on the inner wall of the ice-making cylinder 110.

In a possible embodiment, the ice-making device further includes a heating device disposed at the ice-making cylinder 110. Prior to driving the ice-scraping screw 112 to rotate, the method further includes operation S040. At S040, the heating device is controlled to heat the ice-making cylinder 110.

In this embodiment, the heating device may be an electric heating wire, a heating plate, or any other device capable of generating heat. By controlling the heating device, direct heating of the ice-making cylinder 110 can be achieved to rapidly increase the temperature of the ice-making cylinder 110, thereby allowing the cleaning liquid to better perform its cleaning effect, which is especially more effective in cleaning stubborn dirt and bacteria.

In this embodiment, in the heating process, the ice-making device may monitor the temperature of the ice-making cylinder 110 in real-time, and accurately control power and a heating duration of the heating device to ensure that the temperature of the ice-making cylinder 110 gradually increases, but does not exceed its tolerance range. By reasonably controlling the temperature of the ice-making cylinder 110, not only can the cleaning effect be improved, but also the ice-making cylinder 110 can be effectively protected to extend the service life of the ice-making cylinder 110. By heating the ice-making cylinder 110, the cleaning liquid can better dissolve and scour the dirt and bacteria on the inner wall of the ice-making cylinder 110, to achieve a better cleaning effect.

In this embodiment, the ice-making device includes the ice-making cylinder 110. The ice-making cylinder 110 has the water inlet 111 formed thereon, and has the ice-scraping screw 112 disposed in the ice-making cylinder 110. The method for cleaning the ice-making device includes: obtaining the cleaning start instruction; then in response to the cleaning start instruction, injecting the cleaning liquid into the ice-making cylinder 110 through the water inlet 111, and driving the ice-scraping screw 112 to rotate; and discharging the wastewater in the ice-making cylinder formed after cleaning by using the cleaning liquid after a predetermined duration, to clean the ice-making device. Through the structural design or the aforementioned method of the present disclosure, the ice-making device can be cleaned by injecting the cleaning liquid into the ice-making cylinder 110 and driving the ice-scraping screw 112 in the ice-making device to rotate without disassembling the ice-making device, enabling simple operation, enhancing the convenience of cleaning the ice-making device, and effectively avoiding problems such as dirt and bacteria contamination during the long-time use of the ice-making device.

The present disclosure further provides an apparatus for cleaning an ice-making device. The apparatus for cleaning the ice-making device includes a memory, a processor, and a program for cleaning the ice-making device. The program is stored in the memory and executable on the processor and is configured to implement steps of the method for cleaning an ice-making device as described above.

The apparatus for cleaning the ice-making device provided in the present disclosure can improve the convenience of cleaning the ice-making device by adopting the method for cleaning the ice-making device in the above embodiments. Compared with the related art, the beneficial effects of the apparatus for cleaning the ice-making device provided in the present disclosure are the same as those of the method for cleaning the ice-making device provided in the above embodiments, and other technical features of the apparatus for cleaning the ice-making device are the same as those disclosed in the method of the above embodiments, which are not repeated herein.

The present disclosure further provides an ice-making device. Referring to FIG. 11 to FIG. 13, The ice-making device includes an ice-making cylinder 110. The ice-making cylinder 110 has a water inlet 111 formed thereon, and has the ice-scraping screw 112 disposed in the ice-making cylinder 110. The ice-making device uses the method for cleaning the ice-making device, or the ice-making device further includes the apparatus for cleaning the ice-making device.

In this embodiment, the ice-making cylinder 110 defines a closed space for making ice cubes, and a temperature inside the ice-making cylinder 110 is reduced by a refrigeration system, allowing a liquid in the ice-making cylinder 110 to freeze into ice under the low-temperature environment. The refrigeration system may be a compression refrigeration system, a semiconductor refrigeration system, or any other type of refrigeration system, as long as the liquid in the ice-making cylinder 110 can freeze into ice. The water inlet 111 may be formed at a side wall, a top or a bottom of the ice-making cylinder 110, and is configured to inject liquid into the ice-making cylinder 110 to make ice or inject a cleaning liquid into the ice-making cylinder 110 to clean the ice-making device. In addition, a plurality of water inlets 111 may be provided, one or more of which is configured to only inject a liquid into the ice-making cylinder 110 to make ice, and the other is configured to inject the cleaning liquid into the ice-making cylinder 110 for cleaning. In this way, the ice-making and cleaning operations are more independent from each other, and the use efficiency of the ice-making device is improved. The ice-scraping screw 112 is located inside the ice-making cylinder 110, and includes a spiral scraper formed thereon. The scraper is configured to rotate under the drive of a motor, to detach ice cubes from an inner wall of the ice-making cylinder 110 and deliver the ice cubes for subsequent ice collection and pickup. The ice-scraping screw 112 may further be configured to assist in the circulation and stirring of the cleaning liquid in the ice-making cylinder 110, thereby achieving a cleaning effect.

In a possible embodiment, the ice-making device further includes a drive motor 510 and a transmission mechanism 520. A driving shaft of the drive motor 510 is in transmission connection with the transmission mechanism 520. The transmission mechanism 520 is in transmission connection with the ice-scraping screw 112. In this embodiment, the transmission mechanism 520 may be a gear transmission mechanism 520, a chain transmission mechanism 520, a belt transmission mechanism 520, etc., as long as power transmission between the drive motor 510 and the ice-scraping screw 112 can be realized. The drive motor 510 drives the transmission mechanism 520 to move, to cause the ice-scraping screw 112 to rotate inside the ice-making cylinder 110, so as to detach the ice cubes from the inner wall of the ice-making cylinder 110 and deliver the ice cubes for subsequent ice collection and pickup, or to 112 assist the circulation and stirring of the cleaning liquid in the ice-making cylinder 110, thereby achieving the cleaning effect.

In a possible embodiment, the water inlet 111 is connected to a water supply device 220 through a water supply pipeline 210. The ice-making device further includes a first valve 230 disposed at the water supply pipeline 210. The first valve 230 is configured to be opened for injecting the cleaning liquid into the ice-making cylinder 110 through the water outlet 111; and is configured to be closed in response to a determination that the cleaning liquid reaches a predetermined liquid level and/or a duration for injecting the cleaning liquid reaches a first predetermined duration, to drive the ice-scraping screw 112 to rotate to clean the ice-making device.

In this embodiment, the water supply device 220 may be the tap water system, the water tank, the reservoir, or any other device capable of providing the cleaning liquid. The first valve 230 is disposed at the water supply pipeline 210 and is configured to control the inflow of the cleaning liquid. The first valve 230 may be the solenoid valve, the mechanical valve, or any other device capable of controlling a flow of liquid. By controlling the opening and closing of the first valve 230, it is possible to control the water supply device 220 to supply the cleaning liquid to the ice-making device, to ensure that the cleaning liquid can accurately and timely enter the ice-making cylinder 110 when cleaning is required. When the ice-making device needs to be cleaned, the first valve 230 is opened to allow the cleaning liquid to flow into the ice-making cylinder 110 through the water supply pipeline 210. When the cleaning liquid reaches the predetermined liquid level in the ice-making cylinder 110, the first valve 230 is closed to stop the inflow of the cleaning liquid, and to prevent the backflow of the cleaning liquid when the ice-scraping screw 112 is rotating to clean the ice-making device.

In a possible embodiment, the ice-making cylinder 110 further has a water outlet 113 formed thereon. The ice-making device further includes a second valve 240 disposed at the water outlet 113. The water outlet 113 is configured to discharge wastewater in the ice-making cylinder 110 formed after cleaning by using the cleaning liquid out of the ice-making cylinder 110. The second valve 240 is configured to be opened to discharge the wastewater in the ice-making cylinder 110 formed after cleaning by using the cleaning liquid out of the ice-making cylinder 110 through the water outlet 113.

In this embodiment, the water outlet 113 may be formed at or formed close to the bottom of the ice-making cylinder 110, to facilitate the smooth discharge of the wastewater. When the ice-scraping screw 112 is rotating, the cleaning liquid interacts with the dirt and bacteria on the inner wall of the ice-making cylinder 110 and the ice-scraping screw 112 to form wastewater. The second valve 240 may be the solenoid valve, the mechanical valve, or any other device capable of controlling the on and off of the liquid flow. The second valve 240 can ensure that wastewater can be smoothly discharged from the water outlet 113 when wastewater is required to be discharged, while avoiding accidental outflow of the wastewater or the cleaning liquid when the wastewater is not required to be discharged.

In this embodiment, it is determined whether the duration for driving the ice-scraping screw 112 to rotate reaches the second predetermined duration, and in response to the determination that the duration for driving the ice-scraping screw 112 to rotate reaches the second predetermined duration or in response to receiving the cleaning end instruction, the control system may trigger the opening of the second valve 240. With the opening of the second valve 240, the wastewater in the ice-making cylinder 110 flows out through the water outlet 113 under the action of gravity and/or the second valve 240, thereby completing the discharge of the cleaning wastewater. After the wastewater is discharged, the ice-making device closes the second valve 240 to prevent the residual cleaning liquid or the liquid used for making ice in the ice-making cylinder 110 from flowing out, and to make it convenient for the ice-making device to start a new ice-making cycle or a further cleaning process based on needs, to ensure that the ice-making device can be in the normal operation state.

In this embodiment, the water outlet 113 is connected to the water receiving device 260 through the drainage pipeline 250. The second valve 240 is disposed at the drainage pipeline 250. In this embodiment, the water receiving device 260 may include the water collecting tray or the wastewater collecting bucket configured to collect wastewater discharged from the water outlet 113. In response to the determination that the duration for driving the ice-scraping screw 112 to rotate reaches the second predetermined duration or in response to receiving the cleaning end instruction, the second valve 240 is opened, and the wastewater flows into the water receiving device 260 through the drainage pipeline 250, thereby realizing effective collection and discharge of the wastewater, facilitating treatment of the wastewater, and avoiding possible pollution problems caused by a direct discharge of the wastewater into the environment.

In this embodiment, the water collecting tray of the water receiving device 260 is detachably connected to the drainage pipeline 250, which is convenient for the user to clean and replace. The wastewater collecting bucket may be provided with a handle, which is convenient for the user to lift and pour the wastewater. Meanwhile, to prevent the wastewater from blocking the drainage pipeline 250, the filter screen or other anti-blocking device may be further arranged in the drainage pipeline 250 to ensure that the wastewater can smoothly flow into the water receiving device 260.

In a possible embodiment, the ice-making cylinder 110 further includes the ice outlet 114, and the ice-making device further includes the ice squeezing head 300 detachably mounted at the ice outlet 114. The ice-making device further includes the upper cover 270 movably disposed at the ice outlet 114. The ice squeezing head 300 is configured to squeeze the ice cubes from the ice outlet 114 and discharge the ice cubes. The upper cover 270 is configured to prevent the cleaning liquid from splashing out of the ice outlet 114 or the ice squeezing head 300 when the ice-scraping screw 112 is rotating.

In this embodiment, the ice outlet 114 is the opening on the ice-making cylinder 110 configured to take out ice cubes. The ice squeezing head 300 is detachably mounted at the ice outlet 114, and is configured to squeeze the ice cube from the ice outlet to cause the ice cube to have a certain shape. In this way, the shape of ice cubes can be changed by the ice squeezing head 300 based on needs, to meet different requirements of actual use. The control system determines whether the ice squeezing head is mounted at the ice outlet. In response to the determination that the ice squeezing head 300 is mounted at the ice outlet 114, the control system determines the cleaning mode as the first cleaning mode. In the first cleaning mode, the control system performs the cleaning operation based on predetermined parameters, such as the liquid level of the cleaning liquid, the rotation speed of the ice-scraping screw 112, etc. Due to the presence of the ice squeezing head 300, the cleaning liquid needs to cover part of the surface of the ice squeezing head 300, and thus more cleaning liquid needs to be injected to achieve the desired cleaning effect. In this case, the rotation speed of the ice-scraping screw 112 may be adjusted accordingly to ensure that the surface of the ice squeezing head 300 and the inner wall of the ice-making cylinder 110 are adequately scoured in the cleaning process.

In this embodiment, in the first cleaning mode, the cleaning liquid is injected into the ice-making cylinder 110 to enable the cleaning liquid level to reach the first predetermined liquid level, and the ice-scraping screw 112 is driven to rotate at the first predetermined speed.

In this embodiment, the first predetermined liquid level is set based on the size of the ice squeezing head 300, the volume of the ice-making cylinder 110, and the properties of the cleaning liquid, to ensure that the cleaning liquid can cover the surface of the ice squeezing head 300 and the inner wall of the ice-making cylinder 110, thereby achieving the optimal cleaning effect. In this case, the first predetermined speed is determined based on the viscosity of the cleaning liquid, the material of the ice-making cylinder 110, and the design of the ice-scraping screw 112, to ensure that the ice-scraping screw 112 generates sufficient scouring force when the ice-scraping screw 112 is rotating to remove dirt and bacteria.

In this embodiment, in the second cleaning mode, the cleaning liquid is injected into the ice-making cylinder 110 to enable the cleaning liquid level to reach the second predetermined level, and the ice-scraping screw 112 is driven to rotate at the second predetermined speed.

In this embodiment, in response to the determination that the ice squeezing head 300 is not mounted at the ice outlet 114, the control system determines the cleaning mode as the second cleaning mode. In the second cleaning mode, since there is no ice squeezing head 300, the cleaning liquid only needs to cover the inner wall of the ice-making cylinder 110, and thus the second predetermined liquid level is lower than the first predetermined liquid level. In this case, the second predetermined speed is also lower than the first predetermined speed to adapt to the cleaning requirement when there is no ice squeezing head 300.

In this embodiment, the upper cover 270 may include a sealable panel or a sealing hood configured to close the ice outlet 114 in the cleaning process to prevent the cleaning liquid or the wastewater in the ice-making cylinder 110 formed after cleaning by using the cleaning liquid from splashing out. In this embodiment, the upper cover 270 is also adapted to the ice squeezing head 300, to ensure that the ice squeezing head 300 can be sealed when the ice squeezing head 300 is mounted at the ice outlet 114, thereby preventing the cleaning liquid or wastewater from splashing out of the ice squeezing head 300. Before the ice-scraping screw 112 starts rotating, the ice-making device controls the upper cover 270 to be closed, ensuring safety and cleanliness of the cleaning process. The sealing effect can be further enhanced by providing the sealing structure, such as the rubber or the silicone gasket, between the upper cover 270 and the ice outlet 114. The hinged connection, sliding connection, or other movable connection between the upper cover 270 and the ice-making cylinder 110 allows the upper cover 270 to be easily opened and closed. When the ice-making cylinder 110 needs to be cleaned, the upper cover 270 may be automatically closed by the driving device such as the motor or the cylinder, thereby preventing the cleaning liquid from spilling out of the ice outlet 114 or the ice squeezing head 300 when the ice-scraping screw 112 is rotating. Subsequent to controlling the upper cover 270 to be closed, the ice-scraping screw 112 may start rotating. In this case, due to the presence of the upper cover 270, the cleaning liquid or the wastewater in the ice-making cylinder 110 formed after cleaning by using the cleaning liquid is limited inside the ice-making cylinder 110, which ensures that the cleaning process is performed smoothly.

In a possible embodiment, the ice-making device includes the refrigeration system. The refrigeration system includes the compressor 410, the condenser 420, the evaporator 440, and the throttle device 430. The compressor 410, the condenser 420, the throttle device 430, and the evaporator 440 are sequentially in communication with each other to form the circulation loop. The evaporator 440 is arranged around the ice-making cylinder 110. The circulation loop is provided with is provided with the third valve 450 configured to control the circulation direction of the circulation loop; and/or, the ice-making device further includes the heating device disposed at the ice-making cylinder 110, where the heating device is configured to heat the ice-making cylinder 110.

In this embodiment, the evaporator 440 includes the evaporator first port 441 and the evaporator second port 442, and the evaporator first port 441 is in communication with the evaporator second port 442. When the ice-making device needs to operate to make ice, the refrigeration system starts. The refrigerant is compressed into the high-temperature and high-pressure gas by the compressor 410, converted into the high-pressure liquid after being refrigerated by the condenser 420, then turns to the low-temperature and low-pressure refrigerant liquid by decompression through the throttle device 430, and finally enters the evaporator 440 through the evaporator first port 441, and absorbs heat and evaporates into the refrigerant gas in the evaporator 440 to realize the refrigeration effect. After the refrigeration is completed, the refrigerant gas flows out of the evaporator second port 442 and is sucked into the compressor 410 again. The above processes are performed cyclically to continuously refrigerate the ice-making cylinder 110.

It should be understood that while cleaning the ice-making device, turning on the ice-making function of the ice-making device will cause the temperature of the cleaning liquid to drop rapidly, affecting the cleaning effect, and can even cause the cleaning liquid to freeze to block the cleaning pipeline or the ice-making cylinder 110. Therefore, prior to the cleaning operation, the refrigeration system needs to be stopped to ensure that the cleaning process takes place at the normal temperature or at the higher temperature.

In this embodiment, prior to driving the ice-scraping screw 112 to rotate, the refrigeration system is controlled to stop operating to stop refrigerating the ice-making cylinder 110. In an embodiment, prior to driving the ice-scraping screw 112 to rotate, the refrigeration system sends the signal to the controller of the refrigeration system, and the controller cuts off power to the compressor 410 to stop the compressor 410, thereby stopping the refrigeration cycle. In this case, other components of the refrigeration system, such as the condenser 420, the throttle device 430, and the evaporator 440, will also stop operating accordingly. When the refrigeration system stops operating, the evaporator 440 stops absorbing heat from the ice-making cylinder 110, thereby preventing freezing of the cleaning liquid due to low temperature or excessive low temperature inside the ice-making cylinder 110 in the cleaning process, ensuring the fluidity of the cleaning liquid and the cleaning effect, and further contributing to prolonging the service life of the ice-making cylinder 110 and the refrigeration system. In this embodiment, the third valve 450 may be the reversing valve, the three-way valve, or any other valve capable of realizing circulation loop reversing. By controlling the third valve 450, the third valve 450 adjusts the operation mode of the refrigeration system, to allow the refrigeration system to operate in the refrigeration mode or the heating mode. In an embodiment, the circulation direction of the refrigerant in the circulation loop of the refrigeration system may be changed by the third valve 450. For example, the evaporator 440 that absorbs heat from the ice-making cylinder 110 in the refrigeration mode can be switched to the heat source that releases heat to the ice-making cylinder 110 in the heating mode by the third valve 450, thereby heating the ice-making cylinder 110 to help the cleaning liquid better dissolve and scour dirt and bacteria on the inner wall of ice-making cylinder 110, to improve the cleaning effect. In this embodiment, through the third valve 450, the refrigeration system performs both the function of refrigerating the ice-making cylinder in the ice-making process of the ice-making device and the function of heating the ice-making cylinder in the cleaning process of the ice-making device without an additional heating device, reducing the costs of the ice-making device, and improving the integration and reliability of the ice-making device.

In this embodiment, in the heating process, the ice-making device can control the heating duration and the temperature to ensure that the temperature of the ice-making cylinder 110 is gradually increased, but not too high to avoid damaging the ice-making cylinder 110. After heating, the refrigeration system sends the signal to the controller of the refrigeration system. The controller cuts off the power to the compressor 410 to stop the compressor 410, thereby stopping the refrigeration cycle. In this case, other components of the refrigeration system, such as the condenser 420, the throttle device 430, and the evaporator 440, will also stop operating accordingly. In this way, since the temperature of the ice-making cylinder 110 has increased, the cleaning liquid can better perform its cleaning effect to remove stubborn dirt and bacteria on the inner wall of the ice-making cylinder 110.

In a possible embodiment, the ice-making device further includes the heating device disposed at the ice-making cylinder 110. The heating device may be the electric heating wire, the heating plate, or any other device capable of generating heat. By controlling the heating device, direct heating of the ice-making cylinder 110 can be achieved to rapidly increase the temperature of the ice-making cylinder 110, thereby allowing the cleaning liquid to better perform its cleaning effect, which is especially more effective in cleaning stubborn dirt and bacteria.

In this embodiment, in the heating process, the ice-making device may monitor the temperature of the ice-making cylinder 110 in real-time, and accurately control the power and the heating duration of the heating device to ensure that the temperature of the ice-making cylinder 110 gradually increases, but does not exceed its tolerance range. By reasonably controlling the temperature of the ice-making cylinder 110, not only can the cleaning effect be improved, but also the ice-making cylinder 110 can be effectively protected to extend the service life of the ice-making cylinder 110. By heating the ice-making cylinder 110, the cleaning liquid can better dissolve and scour the dirt and bacteria on the inner wall of the ice-making cylinder 110, to achieve a better cleaning effect.

In this embodiment, the ice-making device includes the ice-making cylinder 110 and the ice-scraping screw 112. The ice-making cylinder 110 has the water inlet 111 formed thereon, and has the ice-scraping screw 112 disposed in the ice-making cylinder 110. The method for cleaning the ice-making device includes: obtaining the cleaning start instruction; then in response to the cleaning start instruction, injecting the cleaning liquid into the ice-making cylinder 110 through the water inlet, and driving the ice-scraping screw 112 to rotate; and discharging the wastewater in the ice-making cylinder 110 formed after cleaning by using the cleaning liquid after a predetermined duration, to clean the ice-making device. Through the structural design or the aforementioned method of the present disclosure, the ice-making device can be cleaned by injecting the cleaning liquid into the ice-making cylinder 110 and driving the ice-scraping screw 112 in the ice-making device to rotate without disassembling the ice-making device, enabling simple operation, enhancing the convenience of cleaning the ice-making device, and effectively avoiding problems such as dirt and bacteria contamination during the long-time use of the ice-making device.

The above description only represents some embodiments of the present disclosure, and does not limit the patent scope of the present disclosure accordingly. Any equivalent structural transformation made by utilizing the contents of the specification and the accompanying drawings of the present disclosure under the technical concept of the present disclosure, or any direct or indirect application in other related technical fields shall all be included within the scope of patent protection of the present disclosure

What is claimed is:

1. A method for cleaning an ice-making device comprising:
obtaining a cleaning start instruction; and
in response to the cleaning start instruction, injecting cleaning liquid into an ice-making cylinder of the ice-making device through a water inlet on the ice-making cylinder, and driving an ice-scraping screw in the ice-making cylinder to rotate to clean the ice-making device.

2. The method according to claim 1, wherein injecting the cleaning liquid into the ice-making cylinder through the water inlet, and driving the ice-scraping screw to rotate to clean the ice-making device includes:
determining, in response to the cleaning start instruction, a cleaning duration and a cleaning mode; and
based on the cleaning duration and the cleaning mode, injecting the cleaning liquid into the ice-making cylinder through the water inlet, and driving the ice-scraping screw to rotate to clean the ice-making device.

3. The method according to claim 2, wherein determining the cleaning duration and the cleaning mode includes:
determining whether the cleaning start instruction is a customized cleaning start instruction, and determining, in response to the determination that the cleaning start instruction is the customized cleaning start instruction, a total cleaning duration and a cleaning mode that are set by a user as the cleaning duration and the cleaning mode based on the customized cleaning start instruction;
determining whether the cleaning start instruction is an intelligent cleaning start instruction, and detecting, in response to the determination that the cleaning start instruction is the intelligent cleaning start instruction, a stain condition of the ice-making cylinder, and determining the cleaning duration and the cleaning mode based on the stain condition; or
determining whether the cleaning start instruction is a one-click cleaning start instruction, and determining, in response to the determination that the cleaning start instruction is the one-click cleaning start instruction, a predetermined cleaning duration and a predetermined cleaning mode as the cleaning duration and the cleaning mode.

4. The method according to claim 2, wherein the cleaning mode includes setting of one or more of following parameters:
a liquid level to be reached by the cleaning liquid injected into the ice-making cylinder;
a rotation direction of the ice-scraping screw;
a rotation mode of the ice-scraping screw;
a rotation speed of the ice-scraping screw;
a number of cleanings; and
when a plurality of cleanings are to be performed, a duration of each of the plurality of cleanings.

5. The method according to claim 2, further comprising:
determining whether an ice squeezing head is mounted at an ice outlet of the ice-making cylinder; and
determining the cleaning mode according to whether the ice squeezing head is mounted, including:
determining the cleaning mode as a first cleaning mode in response to the determination that the ice squeezing head is mounted at the ice outlet; or
determining the cleaning mode as a second cleaning mode in response to the determination that the ice squeezing head is not mounted at the ice outlet, the second cleaning mode differs from the first cleaning mode in at least one of a liquid level to be reached by the cleaning liquid injected into the ice-making cylinder or a rotation speed of the ice-scraping screw.

6. The method according to claim 5, further comprising, prior to driving the ice-scraping screw to rotate:
controlling an upper cover of the ice-making device to close the ice outlet to prevent the cleaning liquid from splashing out of the ice outlet or the ice squeezing head when the ice-scraping screw is rotating.

7. The method according to claim 1, wherein:
the water inlet is connected to a water supply device through a water supply pipeline;
the ice-making device further includes a valve disposed at the water supply pipeline; and
injecting the cleaning liquid into the ice-making cylinder through the water inlet, and driving the ice-scraping screw to rotate to clean the ice-making device includes:
opening the valve to inject the cleaning liquid into the ice-making cylinder through the water inlet; and
determining whether the cleaning liquid reaches a predetermined liquid level and/or a duration for injecting the cleaning liquid reaches a predetermined duration, and closing the valve in response to the determination that the cleaning liquid reaches the predetermined liquid level and/or the duration for injecting the cleaning liquid reaches the predetermined duration, and driving the ice-scraping screw to rotate, to clean the ice-making device.

8. The method according to claim 1, further comprising:
determining whether a duration for driving the ice-scraping screw to rotate reaches a predetermined duration and/or whether a cleaning end instruction is received; and
discharging wastewater in the ice-making cylinder formed after cleaning by using the cleaning liquid from the ice-making cylinder through a water outlet on the ice-making cylinder in response to the determination that the duration for driving the ice-scraping screw to rotate reaches the predetermined duration and/or in response to receiving the cleaning end instruction.

9. The method according to claim 8, wherein:
the ice-making device further includes a valve at the water outlet; and
discharging the wastewater in the ice-making cylinder formed after cleaning by using the cleaning liquid out of the ice-making cylinder through the water outlet in response to the determination that the duration for driving the ice-scraping screw to rotate reaches the predetermined duration and/or in response to receiving the cleaning end instruction includes:
opening the valve in response to the determination that the duration for driving the ice-scraping screw to rotate reaches the predetermined duration and/or in response to receiving the cleaning end instruction, to discharge the wastewater in the ice-making cylinder formed after cleaning by using the cleaning liquid from the ice-making cylinder through the water outlet.

10. The method according to claim 1, further comprising, prior to driving the ice-scraping screw to rotate:
controlling a refrigeration system of the ice-making device to stop operating to stop refrigerating the ice-making cylinder, the refrigeration system including a compressor, a condenser, a throttle device, and an evaporator sequentially in communication with each other to form a circulation loop, and the evaporator being arranged around the ice-making cylinder.

11. The method according to claim 1, further comprising, prior to driving the ice-scraping screw to rotate:
controlling a valve in a circulation loop in a refrigeration system of the ice-making device to operate the refrigeration system in a heating mode to heat the ice-making cylinder, the refrigeration system including a compressor, a condenser, a throttle device, and an evaporator sequentially in communication with each other to form the circulation loop, and the evaporator being arranged around the ice-making cylinder.

12. The method according to claim 1, wherein obtaining the cleaning start instruction includes:
obtaining a cleaning start instruction triggered by a user; or
determining whether the ice-making device accumulatively makes ice for a predetermined duration, and obtaining a cleaning start instruction generated in response to the determination that the ice-making device accumulatively makes ice for the predetermined duration.

13. An apparatus for cleaning an ice-making device, comprising:
a processor; and
a memory storing a program that, when executed by the processor, causes the processor to:
obtain a cleaning start instruction; and
in response to the cleaning start instruction, inject cleaning liquid into an ice-making cylinder of the ice-making device through a water inlet on the ice-making cylinder, and drive an ice-scraping screw in the ice-making cylinder to rotate to clean the ice-making device.

14. An ice-making device comprising:
an ice-making cylinder, having a water inlet; and
an ice-scraping screw in the ice-making cylinder;
wherein the ice-making device is configured to:
obtain a cleaning start instruction; and
in response to the cleaning start instruction, inject cleaning liquid into the ice-making cylinder through the water inlet on the ice-making cylinder, and drive the ice-scraping screw to rotate to clean the ice-making device.

15. The ice-making device according to claim 14, further comprising:
a valve;
wherein:
the water inlet is connected to a water supply device through a water supply pipeline; and
the valve is disposed at the water supply pipeline, and is configured to:
be opened for injecting the cleaning liquid into the ice-making cylinder through the water outlet, and
be closed in response to a determination that the cleaning liquid reaches a predetermined liquid level and/or a duration for injecting the cleaning liquid reaches a predetermined duration.

16. The ice-making device according to claim 14, further comprising:
a valve;
wherein:
a water outlet is formed on the ice-making cylinder and configured to discharge wastewater in the ice-making cylinder formed after cleaning by using the cleaning liquid out of the ice-making cylinder; and
the valve is disposed at the water outlet, and is configured to be opened to discharge the wastewater in the ice-making cylinder formed after cleaning by using the cleaning liquid out of the ice-making cylinder through the water outlet.

17. The ice-making device according to claim 14, further comprising:
an ice squeezing head; and
an upper cover;
wherein:
the ice-making cylinder further includes an ice outlet;
the ice squeezing head is detachably mounted at the ice outlet, and is configured to squeeze an ice cube at the ice outlet and discharge the ice cube; and
the upper cover is movably disposed at the ice outlet, and is configured to prevent the cleaning liquid from splashing out of the ice outlet or the ice squeezing head when the ice-scraping screw is rotating.

18. The ice-making device according to claim 14, further comprising:
a refrigeration system, including a compressor, a condenser, a throttle device, and an evaporator sequentially in communication with each other to form a circulation loop, and the evaporator being arranged around the ice-making cylinder;
wherein the circulation loop is provided with a valve configured to control a circulation direction of the circulation loop.
